(19) United States
(12) Patent Application Publication
(10) Pub. No.: US 2012/0061625 A1
(43) Pub. Date: Mar. 15, 2012

(54) TRANSPARENT CONDUCTIVE FILMS, COMPOSITIONS, ARTICLES, AND METHODS

(76) Inventor: Karissa L. Eckert, Blaine, MN (US)

(21) Appl. No.: 13/152,309

(22) Filed: Jun. 3, 2011

Related U.S. Application Data
(60) Provisional application No. 61/381,192, filed on Sep. 9, 2010.

(51) Int. Cl. H01B 1/22; C08L 75/04; C08L 83/08; C08L 83/06; C08L 1/14; C08L 83/12; B82Y 99/00

(52) U.S. Cl. 252/514; 977/762

(57) ABSTRACT

Transparent conductive films, compositions, articles, and methods and disclosed and claimed. Improved abrasion resistance is provided without adversely affecting coating solution shelf life, film resistivity, or film light transmittance. Such films are useful in such articles as electronic displays, touch screens, and the like.

### CROSS REFERENCE TO RELATED APPLICATIONS

Priority is claimed from U.S. Provisional Application No. 61/381,192, filed Sep. 9, 2010, which is hereby incorporated by reference in its entirety.

### BACKGROUND

Metal nanowire based transparent conductive films can provide excellent electrical conductivity, high light transmittance, and ease of manufacturing on flexible substrates. Transparent conductive films employing networks of silver nanowires are being evaluated to replace indium tin oxide as transparent conductors in many applications. Such transparent conductive films could exhibit resistivities less than about 20 ohms/square with greater than about 86% light transmittance when coated on a polyethylene terephthalate support.

Some applications may expose transparent conductive films to scratching or surface contact with other materials. In such applications, abrasion resistance of the transparent conductive films may become important. Modifications to coating layer compositions to improve abrasion resistance often have the drawback of decreasing the shelf-life of the coating mixes used to make the coating layers. Such modifications may also adversely impact other film properties, such as resistivity and light transmittance.

U.S. Pat. No. 7,153,636 (Ludemann et al.), hereby incorporated by reference in its entirety, discloses use of a combination of a polysiloxane and a modified smectite clay to improve the abrasion resistance of an outermost backside layer of a thermally developable film.

Transparent conductive films, compositions, articles, and methods are disclosed and claimed that provide improved abrasion resistance without adversely impacting coating solution shelf life, film resistivity, or film light transmittance.

### SUMMARY

At least a first embodiment provides a transparent conductive film comprising a transparent substrate and at least one transparent conductive layer disposed on the transparent substrate, where the at least one transparent conductive layer comprises at least one siloxane containing compound, at least one resin, and at least one metal nanoparticle.

The transparent conductive film may, in some cases, comprise at least one of the following: a resistivity less than about 150 ohms/square, an abrasion resistance of at least about 3, or an ASTM D1003 haze value less than about 7%. In at least some embodiments, the transparent conductive film may comprise two or three of these attributes.

In at least some embodiments, the at least one transparent conductive layer may comprise at least one of the following: a resistivity less than about 150 ohms/square, an abrasion resistance of at least about 3, or an ASTM D1003 haze value less than about 7%. Or the at least one transparent conductive layer may, in some cases, comprise two or three of these attributes.

The at least one siloxane containing compound may, in some cases, be present in an amount greater than 3 wt % of that of the at least one resin. In at least some embodiments, the at least one siloxane containing compound may comprise at least one terminal methyl group and at least one diphenyl siloxane repeat unit, phenylmethyl siloxane repeat unit, dimethyl siloxane repeat unit, or (epoxycyclohexylethyl)methyl siloxane repeat unit. In other embodiments, the at least one siloxane containing compound may comprise at least one terminal methyl group, at least one phenylmethyl siloxane repeat unit, and at least one dimethyl siloxane repeat unit. In still other embodiments, the at least one siloxane containing compound may comprise at least one terminal methyl group, at least one dimethyl siloxane repeat unit, and at least one (epoxycyclohexylethyl)methyl siloxane repeat unit. In yet still other embodiments, the at least one siloxane containing compound may comprise at least one terminal methyl group or terminal silanol group; and at least one repeat unit comprising at least one phenyl group, methyl group, aminoethyl group, or aminopropyl group.

The at least one resin may, in some cases, comprise at least one cellulosic polymer, such as, for example, at least one cellulose ester polymer. An exemplary cellulosic polymer is cellulose acetate butyrate polymer.

The at least one metal nanoparticle may, in some cases, comprise at least one nanowire, nanocube, nanorod, nanopyramid, or nanotube. In at least some embodiments, the at least one metal nanoparticle may comprise at least one of the following: at least one nanowire, at least one coinage metal, or silver. An exemplary metal nanoparticle is a silver nanowire.

The at least one transparent conductive layer may, in some cases, comprise at least one compound comprising at least one of a carbamate moiety or an isocyanate moiety.

Other embodiments provide articles comprising such transparent conductive films. In at least some embodiments, such an article may comprise an electronic display, a touch screen, a portable telephone, a cellular telephone, a computer display, a laptop computer, a tablet computer, a point-of-purchase kiosk, a music player, a television, an electronic game, an electronic book reader, or the like.

At least a second embodiment provides a coating composition comprising at least one siloxane containing compound, at least one resin, and at least one metal nanoparticle. In at least some embodiments, a transparent conductive layer can be formed from the coating composition after aging it for at least about four hours, where the transparent conductive layer comprises at least one of the following: a resistivity less than about 150 ohms/square, an abrasion resistance of at least about 3, or an ASTM D1003 haze value less than about 7%. In at least some cases, the coating composition may, for example, be aged for at least about four hours and less than about 24 hours. The coating composition may, in at least some embodiments, further comprise at least one first compound comprising at least one isocyanate moiety and at least one second compound comprising at least one hydroxyl moiety.

Other embodiments provide a transparent conductive film comprising a transparent substrate and a transparent conductive layer disposed on the transparent substrate, where the transparent conductive layer is formed from such a coating composition.

Still other embodiments provide articles comprising such transparent conductive films. In at least some embodiments, such an article may comprise an electronic display, a touch screen, a portable telephone, a cellular telephone, a computer display, a laptop computer, a tablet computer, a point-of-purchase kiosk, a music player, a television, an electronic game, an electronic book reader, or the like.

At least a third embodiment provides a method comprising aging a coating composition for at least four hours to form an aged coating composition, where the coating composition comprises at least one siloxane containing compound at least one resin, and at least one metal nanoparticle; and forming a transparent conductive layer from the aged coating composition, where the transparent conductive layer comprises at least one fir the following: a resistivity less than about 150 ohms/square, an abrasion resistance of at least about 3, or an ASTM D1003 haze value less than about 7%. In some cases, the coating composition may, for example, be aged for at least about four hours and less than about 24 hours. The coating composition may, in some cases, further comprise at least one first compound comprising at least one isocyanate moiety and at least one second compound comprising at least one hydroxyl moiety.

Other embodiments provide a transparent conductive film comprising the transparent conductive layer formed by such methods.

Still other embodiments provide articles comprising such transparent conductive films. In at least some embodiments, such an article may comprise an electronic display, a touch screen, a portable telephone, a cellular telephone, a computer display, a laptop computer, a tablet computer, a point-of-purchase kiosk, a music player, a television, an electronic game, an electronic book reader, or the like.

These and other embodiments will be understood from the description, the examples, and the claims that follow.

### DESCRIPTION

U.S. Provisional Application No. 61/381,192, filed Sep. 9, 2010, is hereby incorporated by reference in its entirety.

### Transparent Conductive Films

Some embodiments provide a transparent conductive film comprising a transparent substrate and a transparent conductive layer disposed on the transparent substrate, where the transparent conductive layer comprises at least one siloxane containing compound, at least one resin, and at least one metal nanoparticle.

In at least some embodiments, the transparent conductive film exhibits a resistivity less than about 1000 ohms/square, or less than about 500 ohms/square, or less than about 150 ohms/square, or less than about 125 ohms/square, or less than about 100 ohms/square. The film resistivity may, for example, be measured using an R-CHECK™ RC2175 four-point resistivity meter (Electronic Design to Market, Toledo Ohio).

In at least some embodiments the transparent conductive film exhibits an abrasion resistance of at least about 2.5, or at least about 3, or at least about 3.5, or at least about 4, or at least about 4.5, or about 5. The film abrasion resistance may, for example, be measured by pushing across the film's surface the rounded tip of a wooden tongue depressor held at a 45-degree angle to the surface. The surface can then be visually inspected and a rated on a 0-5 scale, with:

0 representing 100% removal of the coating,

1 representing greater than 75% removal of the coating,

2 representing 50-74% removal of the coating,

3 representing 25-50% removal of the coating,

3.5 representing 10-25% removal of the coating,

4 representing surface marring with 1-20% removal of the coating,

4.5 representing slight surface marring, and

5 representing no marring of the surface.

Such a measurement may be repeated three additional times, each time using a new tongue depressor. The four measurements may then be averaged.

In at least some embodiments, the transparent conductive film exhibits a haze value less than about 7%, or less than about 6.5%, or less than about 6%. Such a haze value may, for example, be evaluated according to ASTM D1003 using a HAZE-GARD PLUS Hazeometer (BYK-Gardner, Columbia. Md.) and reported as a percentage.

In at least some embodiments, the transparent conductive film exhibits a transmittance of at least about 70%, or at least about 80%, or at least about 85%, or at least about 90%, across the entire spectrum from about 350 nm to about 1100 nm (“total light transmittance”).

### Transparent Substrates

Some embodiments provide a transparent conductive film comprising a transparent substrate. Such transparent substrates may have total visible light transmission greater than about 85%, or greater than about 90%, or greater than about 95%. In at least some embodiments, the transparent substrate may be flexible.

In at least some cases, the transparent substrate may comprise glass or a plastic, such as, for example, a polyester. Such polyesters may, for example, comprise repeat units comprising a first residue from a monomer comprising acid or ester moieties joined by an ester linkage to a second residue from a monomer comprising alcohol moieties. Exemplary repeat units are, for example, ethylene terephthalate, ethylene isophthalate, ethylene naphthalate, diethylene terephthalate, diethylene isophthalate, diethylene naphthalate, cyclohexylene terephthalate, cyclohexylene isophthalate, cyclohexylene naphthalate, and the like. Such polyesters may comprise more than one type of repeat group and may sometimes be referred to as copolyesters. Exemplary polyesters are polyethylene terephthalate (PET) and polyethylene naphthalate (PEN).

In at least some cases, the transparent substrate may comprise other plastics, such as, for example, cellulose polymers, polycarbonates, polyvinyl acetal, polyolefins, stryrenic polymers, and the like.

Transparent substrates may, in some cases, be heat treated or annealed to decrease shrinkage and improve dimensional stability. Their surfaces may be treated to enhance adhesion. Transparent substrates may comprise multiple layers. These and other variations will be understood to those skilled in the art.

### Transparent Conductive Layers

Some embodiments provide at least one transparent conductive layer disposed on the transparent substrate. Such transparent conductive layers may have total visible light transmission greater than about 70%, or greater than about 85%, or greater than about 90%, or greater than about 95%. In some cases, there may be other layers disposed between the at least one transparent conductive layer and the transparent substrate, such as one or more adhesion promoting layers. In at least some embodiments, the layer farthest from the substrate may be a transparent conductive layer.

The at least one transparent conductive layer may comprise at least one metal nanoparticle. For the purpose of this application, a nanoparticle is an object with at least one dimension less than about 100 nm. Examples of nanoparticles include nanowires, nanocubes, nanorods, nanopyramids, nanotubes, and the like. Nanoparticles may be constructed from any of a variety of metals, such as, for example, coinage metals, including silver, gold, copper, and the like. In at least some embodiments, the at least one conductive layer may comprise a conductive network of nanoparticles, such as, for example, a conductive network of nanowires. The concentration of such nanoparticles in the at least one transparent conductive layer is preferably sufficiently high to comprise such a conductive network. While not wishing to be bound by theory, such a concentration may, for example, be higher than a percolation threshold for the at least one transparent conductive layer. However, the concentration of such nanowires should not be so high that it degrades excessively the total visible light transmission through the transparent conductive layer.

In at least some embodiments, the at least one nanoparticle comprises at least one silver nanowire. Such silver nanowires may, for example, comprise aspect ratios from about 20 to about 3300, or to about 500 to 1000. Such silver nanowires may, for example, comprise lengths from about 5 μm to about 100 μm, of from about 15 μm to about 100 μm. Such nanowires may, for example, comprise widths from about 30 nm to about 200 nm. Such silver nanowires may, for example, comprise both widths from about 30 nm to about 200 nm and lengths from about 15 μm to about 100 μm.

Silver nanowires may be prepared by known methods. For example, silver nanowires may be synthesized through solution-phase reduction of at least one silver cation in the presence of at least one polyol and at least one protecting agent. In some cases, silver nitrate may be used as a source of silver cations. Polyols may include, for example, such compounds as ethylene glycol, propylene glycol, butanediol, glycerol, sugars, carbohydrates, and the like. Protecting agents may include, for example, such compounds as polyvinylpyrrolidinone (also known as polyvinylpyrrolidone or PVP), other polar polymers or copolymers, surfactants, acids, and the like. Large-scale production of silver nanowires, including nanowires of relatively uniform size, may be prepared according to methods described in, for example, Ducamp-Sunguesa, C. et al., J. Solid State Chem., 1992, 100, 272-280; Xia, Y. et al., Chem. Mater., 2002, 14, 2736-4745; and Xia, Y. et al., Nanoletters, 2003, 3(7), 955-960.

The at least one transparent conductive layer may comprise one or more resins, such as, for example, one or more polymers, copolymers, or oligomers, such as, for example, acrylic polymers, vinyl polymers, polyesters, polycarbonates, styrenic polymers, polyurethanes, polyolefins, epoxy polymers, cellulosic polymers, silicone polymers, phenolic polymers, fluoropolymers, rubbers, conductive polymers, semiconductive polymers, nonconductive polymers, and the like. The concentration of such polymers, copolymers, or oligomers is preferably low enough not to reduce the conductivity of the layer below that required for the intended application. In some cases, the total weight of all resins may be from about 50 to about 90 wt %, or from about 70 to about 85 wt %, of the dried at least one transparent conductive layer.

In at least some embodiments, the one or more resins may comprise at least one cellulosic polymer. Cellulosic polymers are polysaccharides or derivatives of polysaccharides, that may have degrees of polymerization of, for example, 100, 1000, 10,000, or more. At least some cellulosic polymers comprise glass transition temperatures of at least about 100 ° C. Examples of cellulosic polymers include derivatives of cellulose, such as, for example, esters and ethers of cellulose. Cellulosic esters include cellulose acetates, such as, for example, cellulose acetate, cellulose triacetate, cellulose propionate, cellulose acetate propionate, cellulose acetate butyrate (CAB), and the like. Cellulosic ethers include, for example, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose, and the like. These and other such cellulosic polymers will be understood by those skilled in the art.

In at least some embodiments, the at least one cellulosic polymer may be present in an about from about 40 to about 90 wt %, or from about 60 to about 85 wt %, of the dried transparent conductive layer.

In at least some embodiments, the one or more resins may comprise at least one cellulosic polymer and at least one non-cellulosic polymer, where the at least one cellulosic polymer makes up at least about 50 wt % of the one or more resins and the at least one non-cellulosic polymer makes up less than about 50 wt % of the one or more resins. The most useful of non-cellulosic polymers are those that upon drying form a single transparent phase with the at least one cellulosic polymer. Such non-cellulosic polymers may, for example, include such polyesters as polyethylene terephthalate, polyethylene naphthalate, and the like.

In at least some embodiments, the at least one transparent conductive layer may comprise at least one compound comprising at least one functional group comprising at least one atom comprising lone pair electrons. Such an atom comprising lone pair electrons may, for example, comprise nitrogen, oxygen, or sulfur. Such functional groups may, for example, comprise hydroxyl groups, carboxylate groups, and the like. Such compounds may, for example, exhibit good solubility in solvents contained in coating mixes. While not wishing to be bound by theory, it is believed that such lone pair electrons may improve stabilization of silver nanowires during their dispersion and during coating of the at least one transparent conductive layer.

In at least some embodiments, the at least one transparent conductive layer may comprise at least one siloxane containing compound. The at least one siloxane containing compound may, in some cases, be present in an amount greater than 3 wt % of that of the one or more resins. In at least some embodiments, the at least one siloxane containing compound may comprise at least one terminal methyl group and at least one diphenyl siloxane repeat unit, phenylmethyl siloxane repeat unit, dimethyl siloxane repeat unit, or (epoxycyclohexylethyl)methyl siloxane repeat unit. In other embodiments, the at least one siloxane containing compound may comprise at least one terminal methyl group, at least one phenylmethyl siloxane repeat unit, and at least one dimethyl siloxane repeat unit. In still other embodiments, the at least one siloxane containing compound may comprise at least one terminal methyl group, at least one dimethyl siloxane repeat unit, and at least one (epoxycyclohexylethyl)methyl siloxane repeat unit. In yet still other embodiments, the at least one siloxane containing compound may comprise at least one terminal methyl group or terminal silanol group; and at least one repeat unit comprising at least one phenyl group, methyl group, aminoethyl group, or aminopropyl group.

In at least some embodiments, the at least one transparent conductive layer may comprise at least one compound comprising at least one of a carbamate moiety or an isocyanate moiety. For example, the transparent conductive layer may, for example, comprise one or more polymers or oligomers that comprise one or more carbamate moieties. Or the transparent conductive layer may, for example, comprise unreacted monomers or crosslinkers that comprise one or more isocyanate moieties. Such compounds may, in some cases, be used to crosslink cellulose polymers comprising hydroxyl groups.

In some cases, the at least one transparent conductive layer may comprise at least one compound comprising at least one hydroxyl moiety. Such compounds may include solvents, polymers, oligomers, unreacted monomers or crosslinkers, and the like.

The at least one transparent conductive layer may optionally comprise other additive components, such as corrosion inhibitors, viscosity modifiers, surfactants, and the like. These and other additive components will be understood by those skilled in the art. The concentration of such additives is preferably low enough not to reduce the conductivity of the layer below that required for the intended application.

In some cases, the at least one transparent conductive layer exhibits a resistivity less than about 1000 ohms/square, or less than about 500 ohms/square, or less than about 150 ohms/square, or less than about 125 ohms/square, or less than about 100 ohms/square. The transparent conductive layer resistivity may, for example, be measured using an R-CHECK™ RC2175 four-point resistivity meter (Electronic Design to Market, Toledo Ohio).

In some cases, the at least one transparent conductive layer exhibits an abrasion resistance of at least about 2.5, or at least about 3, or at least about 3.5, or at least about 4, or at least about 4.5, or about 5. The layer abrasion resistance may, for example, be measured by pushing across the layer the rounded tip of a wooden tongue depressor held at a 45-degree angle to the surface. The surface can then be visually inspected and a rated on a 0-5 scale, as described above. Such a measurement may be repeated three additional times, each time using a new tongue depressor. The four measurements may then be averaged.

In some cases, the at least one transparent conductive layer exhibits a haze value less than about 7%, or less than about 6.5%, or less than about 6%, or less than about 5.5%, or less than about 5%, or less than about 4.5%. Such a haze value may, for example, be evaluated according to ASTM D1003 using a HAZE-GARD PLUS Hazeometer (BYK-Gardner, Columbia. Md.) and reported as a percentage. The haze value for such a layer may be determined from the difference of haze values of samples with and without the layer.

### Coating Compositions

Some embodiments provide coating compositions comprising at least one silane containing compound, at least one resin, and at least one nanoparticle. Such coating compositions may generally comprise any of the silane containing compounds, resins, or nanoparticles described earlier for the transparent conductive layer.

For example. when coating compositions comprise silver nanowires, silver nanowire coating weights of about 10 mg/m² to about 120 mg/m², or from about 50 mg/m² to about 90 mg/m² may be used. Transparent conductive layers formed from such coating compositions may, for example, comprise dry thicknesses of from about 0.05 μm to about 2.0 μm, of from about 0.2 μm to about 1.0 μm.

In at least some embodiments, a transparent conductive layer can be formed from such a coating composition after aging it for at least about four hours, where the transparent conductive layer comprises at least one of the following: a resistivity less than about 150 ohms/square, an abrasion resistance of at least about 3, or an ASTM D1003 haze value less than about 7%. In at least some cases, such a coating composition may, for example, be aged for at least about four hours and less than about 24 hours.

Such coating compositions may also include one or more solvents, such as, for example, one or more of toluene, methyl ethyl ketone, methyl iso-butyl ketone, acetone, methanol, ethanol, 2-propanol, ethyl actetate, propyl acetate, ethyl lactate, tetrahydrofuran, and the like.

Such coating compositions may also include monomers, initiators, and the like, that may be reacted to form oligomers or polymers. For example, the coating composition may, in at least some embodiments, further comprise at least one first compound comprising at least one isocyanate moiety and at least one second compound comprising at least one hydroxyl moiety.

Coating compositions may optionally comprise other additive components, such as corrosion inhibitors, viscosity modifiers, surfactants, and the like. These and other additive components will be understood by those skilled in the art. The concentration of such additives is preferably low enough not to reduce the conductivity of layers formed from such coating compositions below that required for the intended application.

### Methods

Other embodiments provide methods for forming transparent coating layers from such coating compositions. In at least some embodiments, such methods may comprise aging a coating composition for at least about four hours, or for at least about four hours and less than about 24 hours.

Such methods may comprise disposing one or more coating mixes on the transparent substrate to form one or more transparent coating layers, such as, for example, one or more transparent conductive layers. The various coating mixes may use the same or different solvents, such as, for example, water or organic solvents. Layers may be coated one at a time, or two or more layers may be coated simultaneously, for example, through use of slide coating.

Layers may be coated using any suitable methods, including, for example, dip-coating, wound-wire rod coating, doctor blade coating, air knife coating, roll coating, gravure roll coating, reverse-roll coating, slide coating, bead coating, extrusion coating, curtain coating, slot-die coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety.

Such methods may comprise drying one or more coated layers, using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety.

Still other embodiments provide transparent conductive films comprising transparent conductive layers formed by such methods.

### Other Layers

In at least some embodiments, the transparent conductive film further comprises at least one layer disposed between the transparent substrate and the at least one transparent conductive layer. Such a layer may, for example, might be provided to improve adhesion between the transparent substrate and the at least one conductive layer.

Or the transparent conductive film might, for example, further comprise at least one layer disposed on the at least one transparent conductive layer. Such layers might comprise electronic device functional layers, such as, for example, active layers for organic photovoltaic devices or active layers for organic light emitting diodes. Or they might comprise structural layers, such as, for example, overcoat layers.

Or the transparent conductive film might, for example, further comprise at least one layer disposed on the side of the transparent substrate opposite that which the at least one transparent conductive layer is disposed. Such layers may comprise, for example, additional conductive layers, backcoat layers, electronic device active layers, structural layers, and the like.

### Articles

Some embodiments provide articles comprising transparent conductive films. Such articles may, for example, comprise electronic displays, touch screens, and the like, for use in such applications as portable telephones, cellular telephones, computer displays, laptop computers, tablet computers, point-of-purchase kiosks, music players, televisions, electronic games, electronic book readers, and the like. These and other articles will be understood by those skilled in the art.

### EXAMPLES

### Materials

Unless otherwise noted, materials were available from Sigma-Aldrich, Milwaukee, Wis.

ATM-1322 is a branched [2-4% aminoethylaminopropylmethoxy-silane]-dimethylsiloxane copolymer having a viscosity of 200-300 cSt (Gelest).

BYK®-333 is a polyether-modified polydimethylsiloxane (Byk).

CMS-626 is a [40% hydroxyethyleneoxypropylmethylsiloxane]-dimethylsiloxane copolymer having a viscosity of 550-650 cSt (Gelest).

DBE-C25 is a hydroxy(polyethyleneoxy)propylether terminated poly(dimethylsiloxane) block copolymer having a viscosity of 400-450 cSt (Gelest).

DESMODUR® N-3300 is 2,2,4-trimethylhexamethylene diioscyanate (Bayer).

DMS-S31 is a silanol-terminated polydimethylsiloxane having a viscosity of 1000 cSt (Gelest).

DMS-S35 is a silanol-terminated polydimethylsiloxane having a viscosity of 5000 cSt (Gelest).

EASTMAN® CAB171-15 is a cellulose acetate butyrate polymer (Eastman Chemical).

ECMS-924 is an [8-10% (epoxycyclohexylethyl)methylsiloxane]-dimethylsiloxane copolymer having a viscosity of 300-450 cSt (Gelest).

DOW CORNING 510® FLUID is a phenylmethyl siloxane polymer having a viscosity of 500 cSt (Dow Coming).

FMS-141 is poly(3,3,3-trifluoropropylmethyl siloxane) having a viscosity of 10,000 cSt (Gelest).

Mayer Bars are ½-in diameter coating rods made from Type 303 stainless steel. (R.D. Specialties, Webster, N.Y.).

PDV-0525 is a vinyl-terminated [4-6% diphenylsiloxane]-dimethyl siloxane copolymer having a viscosity of 500 cSt (Gelest).

Silver nanowires were available from Seashell Technologies, LLC, LaJolla, Calif.

TEGO® GLIDE 410 is a polyether siloxane copolymer having a viscosity of 1850 mPa·s (Evonik).

### Methods

The transparent films of the Examples were evaluated for coated surface electrical resistivity, coating abrasion resistance, and haze.

Abrasion resistance was evaluated by pushing across the coating the rounded tip of a wooden tongue depressor held at a 45-degree angle to the surface. The coated surface was then visually inspected and a rating assigned, based on a 0-5 scale, with:

0 representing 100% removal of the coating,

1 representing greater than 75% removal of the coating,

2 representing 50-74% removal of the coating,

3 representing 25-50% removal of the coating,

3.5 representing 10-25% removal of the coating,

4 representing surface marring with 1-20% removal of the coating,

4.5 representing slight surface marring, and

5 representing no marring of the surface.

This procedure was repeated three additional times for each sample, each time using a new tongue depressor. The average of the four ratings for each sample was recorded.

Haze was evaluated according to ASTM D1003 using a HAZE-GARD PLUS Hazeometer (BYK-Gardner, Columbia. Md.).

Electrical resistivities of the coated surfaces were measured using an R-CHECK™ RC2175 four-point resistivity meter (Electronic Design to Market, Toledo Ohio), using the manufacturer recommended procedure.

### Example 1 (Comparative)

Silver nanowires were prepared according to the procedure of B. Wiley, Y. Sun., Y. Zia, Langmuir, 2005, 21(18), 8007, which is hereby incorporated by reference in its entirety. The silver nanowires so prepared had diameters ranging from about 80 nm to about 140 nm and lengths ranging from about 10 μm to about 50 μm. The silver nanowires were mixed with 2-propanol to form a 5 wt % dispersion.

Solution A was prepared by mixing 12.0 g of EASTMAN® CAB171-15 cellulose acetate butyrate polymer, 288.0 g of methyl ethyl ketone (MEK), and 0.06 g of phthalazone.

Solution B was prepared by mixing 10.72 g of Solution A, 0.11 g of DESMODUR® N-3300, 0.02 g of bismuth neodecanoate, 24.11 g of ethyl lactate, 16.07 g of isopropanol, and 5.36 g of MEK.

To a 2.97 g aliquot of Solution B was added 0.19 g of the 5 wt % silver nanowire dispersion. The dispersion was mixed on a shaker at low speed for 5 min. A portion of this coating dispersion was set aside for use in Example 4. The coating dispersion was then coated onto a 7-mil clear polyethylene terephthalate support using a #10 Mayer rod. The resulting coated support was dried in an oven at 104 ° C. for 4 min to obtain a transparent coated film.

The transparent coated film was evaluated for coated surface electrical resistivity, coated surface abrasion resistance, and haze. The results are shown in Table II.

### Example 2 (Comparative)

To each of several 2.97 g aliquots of Solution B of were added 0.19 g of the 5 wt % silver nanowire dispersion and 0.10 g of a 1 wt % mixture of DBE-C25 copolymer in MEK, to form the dispersions detailed in Table I. Each of the resulting dispersions was mixed on a shaker at low speed for 5 min. A portion of each of these coating dispersions was set aside for use in Example 4. Each of the coating dispersions was then coated onto a 7-mil clear polyethylene terephthalate support using a #10 Mayer rod. The resulting coated supports were dried in an oven at 104 ° C. for 4 min to obtain transparent coated films.

The transparent coated films were evaluated for coated surface abrasion resistance, haze, and coated surface electrical resistivity. The results are shown in Table II.

### Example 3

To each of several 2.97 g aliquots of Solution B were added 0.19 g of the 5 wt % silver nanowire dispersion and 0.10 g of a 1 wt % mixture of a siloxane containing compound in MEK, to form the dispersions detailed in Table I. Each of the resulting dispersions was mixed on a shaker at low speed for 5 min. A portion of each of these coating dispersions was set aside for use in Example 4. Each of the coating dispersions was then coated onto a 7-mil clear polyethylene terephthalate support using a #10 Mayer rod. The resulting coated supports were dried in an oven at 104 ° C. for 4 min to obtain transparent coated films.

The transparent coated films were evaluated for coated surface abrasion resistance, haze, and coated surface electrical resistivity. The results are shown in Table II.

### Example 4

A portion of each of the coating dispersions of Examples 1-3 was held for 24 hours at room temperature, after which the coating procedure of Example 1 was repeated to form a transparent films for evaluation. The transparent coated films were evaluated for coated surface abrasion resistance, haze, and coated surface electrical resistivity. The results are shown in Table II.

### Example 5 (Comparative)

To each of several 2.97 g aliquots of Solution B of were added 0.19 g of the 5 wt % silver nanowire dispersion and 0.10 g of a 1 wt % mixture of DBE-C25 copolymer in MEK, to form the dispersions detailed in Table III. Each of the resulting dispersions was mixed on a shaker at low speed for 5 min. A portion of each of these coating dispersions was set aside for use in Example 7. Each of the coating dispersions was then coated onto a 7-mil clear polyethylene terephthalate support using a #10 Mayer rod. The resulting coated supports were dried in an oven at 104 ° C. for 4 min to obtain transparent coated films.

The transparent coated films were evaluated for coated surface abrasion resistance, haze, and coated surface electrical resistivity. The results are shown in Table IV.

### Example 6

To each of several 2.97 g aliquots of Solution B were added 0.19 g of the 5 wt % silver nanowire dispersion and 0.10 g of a 1 wt % mixture of a siloxane containing compound in MEK, to form the dispersions detailed in Table III. Each of the resulting dispersions was mixed on a shaker at low speed for 5 min. A portion of each of these coating dispersions was set aside for use in Example 7. Each of the coating dispersions was then coated onto a 7-mil clear polyethylene terephthalate support using a #10 Mayer rod. The resulting coated supports were dried in an oven at 104 ° C. for 4 min to obtain transparent coated films.

The transparent coated films were evaluated for coated surface abrasion resistance, haze, and coated surface electrical resistivity. The results are shown in Table IV.

### Example 7

A portion of each of the coating dispersions of Examples 5-6 was held for 24 hours at room temperature, after which the coating procedure of Example 1 was repeated to form a transparent films for evaluation. The transparent coated films were evaluated for coated surface abrasion resistance, haze, and coated surface electrical resistivity. The results are shown in Table IV.

### Discussion

Referring to Tables I and II, the comparative samples made from coating solutions with no siloxane-containing compound showed poor abrasion resistance when made from the un-aged coating solution and essentially no abrasion resistance when made from the 24-hour old coating solution. Electrical resistivity of was also worse for the coating made from the 24-hour old coating solution compared to that made from the un-aged coating solution.

The comparative samples made from coating solutions comprising the DBE-C25 copolymer (“PS-4”) exhibited essentially no abrasion resistance. Electrical resistivity was also worse for the coating made from the 24-hour old coating solution compared to that made from the un-aged coating solution.

Referring to Tables III and IV, the comparative samples comprising the PDV-0525 copolymer (“PS-5”) exhibited poor abrasion resistance at the 5% level and high electrical resistivity at all levels. The comparative samples comprising the FMS-141 polymer (“PS-6”) exhibited high electrical resistivity and abrasion resistance that deteriorated over 24 hrs. The comparative samples comprising the CMS-626 copolymer (“PS-7”) exhibited essentially no initial abrasion resistance, poor abrasion resistance at 24 hrs, and high electrical resistivities.

Referring to Tables I-IV, the samples made from coating solutions comprising the other siloxane containing compounds (“PS-1” through “PS-4” and “PS-8” through “PS-11”) at levels of about 3% or greater relative to that of the cellulose acetate butyrate showed improved abrasion resistance, with all exhibiting abrasion scores of about 3 or higher when made from 24-hour old coating solutions. Haze levels for these samples were also comparable to or better than those for the comparative samples, with all exhibiting haze values below about 7% when made from 24-hour old coating solutions. Electrical resistivities for these samples were also comparable to or lower those for the comparative examples, with all exhibiting electrical resistivities below about 300 ohms/square when made from 24-hour old coating solutions. Many of these samples exhibited electrical resistivities below about 150 ohms/square when made from 24-old coating solutions.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE I

| Sample | | Coating Solu- | |
|---|---|---|---|
| ID | Siloxane Containing Compound | tion Age | |
| 1-1 | — | 0 | hrs |
| 2-1 | 5% DBE-C25 (“PS-4”) | 0 | hrs |
| 2-2 | 10% DBE-C25 (“PS-4”) | 0 | hrs |
| 3-1 | 5% DOW CORNING 510 ® FLUID (“PS-1”) | 0 | hrs |
| 3-2 | 3% ECMS-924 (“PS-2”) | 0 | hrs |
| 3-3 | 7% ECMS-924 (“PS-2”) | 0 | hrs |
| 3-4 | 10% ECMS-924 (“PS-2”) | 0 | hrs |
| 3-5 | 3% TEGO ® GLIDE 410 (“PS-3”) | 0 | hrs |
| 3-6 | 5% TEGO ® GLIDE 410 (“PS-3”) | 0 | hrs |
| 4-1-1 | — | 24 | hrs |
| 4-2-1 | 5% DBE-C25 (“PS-4”) | 24 | hrs |
| 4-2-2 | 10% DBE-C25 (“PS-4”) | 24 | hrs |
| 4-3-1 | 5% DOW CORNING 510 ® FLUID (“PS-1”) | 24 | hrs |
| 4-3-2 | 3% ECMS-924 (“PS-2”) | 24 | hrs |
| 4-3-3 | 7% ECMS-924 (“PS-2”) | 24 | hrs |
| 4-3-4 | 10% ECMS-924 (“PS-2”) | 24 | hrs |
| 4-3-5 | 3% TEGO ® GLIDE 410 (“PS-3”) | 24 | hrs |
| 4-3-6 | 5% TEGO ® GLIDE 410 (“PS-3”) | 24 | hrs |

TABLE II

| | % | Solution | | Abrasion | | Resistivity |
|---|---|---|---|---|---|---|
| Sample ID | Siloxane | Age | | Resistance | Haze (%) | (ohms/s) |
| 1-1 | — | 0 | hrs | 2.3 | 6.71 | 121.8 |
| 4-1-1 | — | 24 | hrs | 0.0 | 6.68 | 209.5 |
| 2-1 | 5% PS-4 | 0 | hrs | 0.0 | 5.75 | 81.8 |
| 4-2-1 | 5% PS-4 | 24 | hrs | 0.0 | 5.95 | 99.0 |
| 2-2 | 10% PS-4 | 0 | hrs | 0.0 | 5.78 | 148.0 |
| 4-2-2 | 10% PS-4 | 24 | hrs | 0.0 | 5.87 | 156.0 |
| 3-1 | 5% PS-1 | 0 | hrs | 5.0 | 5.49 | 107.3 |
| 4-3-1 | 5% PS-1 | 24 | hrs | 2.9 | 5.68 | 264.0 |
| 3-2 | 3% PS-2 | 0 | hrs | 5.0 | 5.78 | 110.3 |
| 4-3-2 | 3% PS-2 | 24 | hrs | 2.8 | 5.97 | 149.3 |
| 3-3 | 7% PS-2 | 0 | hrs | 5.0 | 5.99 | 96.3 |
| 4-3-3 | 7% PS-2 | 24 | hrs | 4.0 | 6.30 | 129.0 |
| 3-4 | 10% PS-2 | 0 | hrs | 5.0 | 6.41 | 149.5 |
| 4-3-4 | 10% PS-2 | 24 | hrs | 5.0 | 6.20 | 135.8 |
| 3-5 | 3% PS-3 | 0 | hrs | 5.0 | 6.13 | 84.0 |
| 4-3-5 | 3% PS-3 | 24 | hrs | 4.0 | 6.50 | 117.8 |
| 3-6 | 5% PS-3 | 0 | hrs | 5.0 | 6.21 | 72.8 |
| 4-3-6 | 5% PS-3 | 24 | hrs | 5.0 | 6.40 | 138.8 |

TABLE III

| Sample | | Coating Solu- | |
|---|---|---|---|
| ID | Siloxane Containing Compound | tion Age | |
| 5-1 | 5% PDV-0525 (“PS-5”) | 0 | hrs |
| 5-2 | 10% PDV-0525 (“PS-5”) | 0 | hrs |
| 5-3 | 10% FMS-141 (“PS-6”) | 0 | hrs |
| 5-4 | 5% CMS-626 (“PS-7”) | 0 | hrs |
| 5-5 | 10% CMS-626 (“PS-7”) | 0 | hrs |
| 6-1 | 5% ATM-1322 (“PS-8”) | 0 | hrs |
| 6-2 | 10% ATM-1322 (“PS-8”) | 0 | hrs |
| 6-3 | 7% DMS-S31 (“PS-9”) | 0 | hrs |
| 6-4 | 10% DMS-S31 (“PS-9”) | 0 | hrs |
| 6-5 | 10% DMS-S35 (“PS-10”) | 0 | hrs |
| 6-6 | 5% BYK ®-333(“PS-11”) | 0 | hrs |
| 7-5-1 | 5% PDV-0525 (“PS-5”) | 24 | hrs |
| 7-5-2 | 10% PDV-0525 (“PS-5”) | 24 | hrs |
| 7-5-3 | 10% FMS-141 (“PS-6”) | 24 | hrs |
| 7-5-4 | 5% CMS-626 (“PS-7”) | 24 | hrs |
| 7-5-5 | 10% CMS-626 (“PS-7”) | 24 | hrs |
| 7-6-1 | 5% ATM-1322 (“PS-8”) | 24 | hrs |
| 7-6-2 | 10% ATM-1322 (“PS-8”) | 24 | hrs |
| 7-6-3 | 7% DMS-S31 (“PS-9”) | 24 | hrs |
| 7-6-4 | 10% DMS-S31 (“PS-9”) | 24 | hrs |
| 7-6-5 | 10% DMS-S35 (“PS-10”) | 24 | hrs |
| 7-6-6 | 5% BYK ®-333 (“PS-11”) | 24 | hrs |

TABLE IV

| | % | Solution | | Abrasion | | Resistivity |
|---|---|---|---|---|---|---|
| Sample ID | Siloxane | Age | | Resistance | Haze (%) | (ohms/sq) |
| 5-1 | 5% PS-5 | 0 | hrs | 3.8 | 5.23 | 436.5 |
| 7-5-1 | 5% PS-5 | 24 | hrs | 3.0 | 5.90 | 1619.3 |
| 5-2 | 10% PS-5 | 0 | hrs | 4.3 | 5.83 | 722.8 |
| 7-5-2 | 10% PS-5 | 24 | hrs | 5.0 | 5.60 | 3064.0 |
| 5-3 | 10% PS-6 | 0 | hrs | 4.0 | 5.67 | 309.0 |
| 7-5-3 | 10% PS-6 | 24 | hrs | 3.3 | 5.70 | 955.0 |
| 5-4 | 5% PS-7 | 0 | hrs | 0.0 | 6.18 | 238.3 |
| 7-5-4 | 5% PS-7 | 24 | hrs | 1.0 | 6.30 | 8307.5 |
| 5-5 | 10% PS-7 | 0 | hrs | 0.0 | 5.77 | 2254.3 |
| 7-5-5 | 10% PS-7 | 24 | hrs | 2.0 | 6.90 | 2674.5 |
| 6-1 | 5% PS-8 | 0 | hrs | 5.0 | 5.57 | 92.0 |
| 7-6-1 | 5% PS-8 | 24 | hrs | 5.0 | 6.00 | 118.0 |
| 6-2 | 10% PS-8 | 0 | hrs | 5.0 | 6.21 | 102.8 |
| 7-6-2 | 10% PS-8 | 24 | hrs | 5.0 | 5.80 | 116.3 |
| 6-3 | 7% PS-9 | 0 | hrs | 4.6 | 5.59 | 158.8 |
| 7-6-3 | 7% PS-9 | 24 | hrs | 4.8 | 6.10 | 362.2 |
| 6-4 | 10% PS-9 | 0 | hrs | 4.4 | 5.59 | 177.0 |
| 7-6-4 | 10% PS-9 | 24 | hrs | 5.0 | 6.20 | 187.8 |
| 6-5 | 10% PS-10 | 0 | hrs | 4.0 | 5.32 | 164.0 |
| 7-6-5 | 10% PS-10 | 24 | hrs | 5.0 | 5.60 | 260.8 |
| 6-6 | 5% PS-11 | 0 | hrs | 5.0 | 5.69 | 331.3 |
| 7-6-6 | 5% PS011 | 24 | hrs | 4.5 | 6.14 | 336.7 |

1. A transparent conductive film comprising:
a transparent substrate; and
at least one transparent conductive layer disposed on the transparent substrate, said transparent conductive layer comprising at least one siloxane containing compound, at least one resin, and at least one metal nanoparticle.

2. The transparent conductive film according to claim 1, comprising at least one of the following: a resistivity less than about 150 ohms/square, an abrasion resistance of at least about 3, or an ASTM D1003 haze value less than about 7%.

3. The transparent conductive film according to claim 1, wherein the at least one siloxane containing compound is present in an amount greater than about 3 wt % of that of the at least one resin.

4. The transparent conductive film according to claim 1, wherein the at least one siloxane compound comprises at least one terminal methyl group and at least one diphenyl siloxane repeat unit, phenylmethyl siloxane repeat unit, dimethyl siloxane repeat unit, or (epoxycyclohexylethyl)methyl siloxane repeat unit.

5. The transparent conductive film according to claim 1, wherein the at least one siloxane compound comprises: at least one terminal methyl group or terminal silanol group; and at least one repeat unit comprising at least one phenyl group, methyl group, aminoethyl group, or aminopropyl group.

6. The transparent conductive film according to claim 1, wherein the at least one resin comprises at least one of a cellulosic polymer, a cellulose ester polymer, or a cellulose acetate butyrate polymer.

7. The transparent conductive film according to claim 1, wherein the at least one metal nanoparticle comprises at least one nanowire, nanocube, nanorod, nanopyramid, or nanotube.

8. The transparent conductive film according to claim 1, wherein the at least one metal nanowire comprises at least one of the following: at least one nanowire, at least one coinage metal, or silver.

9. The transparent conductive film according to claim 1, wherein the at least one transparent conductive layer comprises at least one compound comprising at least one of a carbamate moiety or an isocyanate moiety.

10. An article comprising the transparent conductive film according to claim 1.

11. A coating composition comprising at least one siloxane containing compound, at least one resin, and at least one metal nanoparticle.

12. The coating composition according to claim 11, wherein a transparent conductive layer can be formed from the coating composition after aging said coating composition for at least about four hours, and further wherein the transparent conductive layer comprises at least one of the following: a resistivity less than about 150 ohms/square, an abrasion resistance of at least about 3, or an ASTM D1003 haze value less than about 7%.

13. The coating composition according to claim 11, wherein the transparent conductive layer can be formed after aging the coating composition for at least about four hours and less than about 24 hours.

14. The coating composition according to claim 11, further comprising at least one first compound comprising at least one isocyanate moiety and at least one second compound comprising at least one hydroxyl moiety.

15. A transparent conductive film comprising:
a transparent substrate; and
a transparent conductive layer disposed on the transparent substrate,
wherein the transparent conductive layer is formed from the coating composition according to claim 12.

16. An article comprising the transparent conductive film according to claim 15.

17. A method comprising:
aging a coating composition for at least about four hours to form an aged coating composition, said coating composition comprising at least one siloxane containing compound, at least one resin, and at least one metal nanoparticle; and
forming a transparent conductive layer from the aged coating composition,
wherein the transparent conductive layer comprises at least one of the following: a resistivity less than about 150 ohms/square, an abrasion resistance of at least about 3, or an ASTM D1003 haze value less than about 7%.

18. The method according to claim 17, wherein the coating composition is aged for at least about four hours and less than about 24 hours.

19. The method according to claim 17, wherein the coating composition further comprises at least one first compound comprising at least one isocyanate moiety and at least one second compound comprising at least one hydroxyl moiety.

20. A transparent conductive film comprising the transparent conductive layer formed by the method of claim 17.

21. An article comprising the transparent conductive film according to claim 20.
